(19) United States
(12) Patent Application Publication
(10) Pub. No.: US 2013/0101030 A1
(43) Pub. Date: Apr. 25, 2013

(54) TRANSMISSION OF VIDEO DATA

(71) Applicants: Pontus Carlsson, Bromma (SE); Andrei Jefremov, Jarfalla (SE); Sergey Sablin, Bromma (SE); David Zhao, Solna (SE)

(72) Inventors: Pontus Carlsson, Bromma (SE); Andrei Jefremov, Jarfalla (SE); Sergey Sablin, Bromma (SE); David Zhao, Solna (SE)

(21) Appl. No.: 13/341,464

(22) Filed: Dec. 30, 2011

(30) Foreign Application Priority Data
Oct. 20, 2011 (GB) 1118117.9

(51) Int. Cl. H04N 7/26

(52) U.S. Cl. 375/240.12; 375/240.01; 375/240.25; 375/E07.027; 375/E07.026; 375/E07.243

(57) ABSTRACT

In an embodiment, a method of transmitting video data includes at an encoder encoding the video data as a plurality of frames, including reference frames and intermediate frames, at least some of which are encoded based on multiple reference frames; at the encoder maintaining for each frame a current list of reference frames; and transmitting the plurality of frames, each frame being transmitted in association with a current list of reference frames for that frame.

### RELATED APPLICATION

This application claims priority under 35 U.S.C. §119 or 365 to Great Britain Application No. GB 1118117.9, filed Oct. 20, 2011. The entire teachings of the above application are incorporated herein by reference.

### TECHNICAL FIELD

The present invention relates to transmission of video data.

### BACKGROUND

Due to the high bit rates required for transmission of video data, various different types of compression are known to reduce the number of bits that are needed to convey a moving image. When compressing the video data, there is a trade off between the number of bits which are required to be transmitted over a transmission channel, and the resolution and accuracy of the moving image.

A video image is conveyed in frames, each frame comprising a set, e.g. 8×8, of macroblocks. A macroblock can be for example a 16×16 blocks of pixels. To generate the missing image, all frames in a particular sequence should ideally be present.

A known compression technique for transmitting video data is to use so-called reference frames.

When compressing blocks of video data, the encoding process generates intra frames (I-frames). An intra frame is a compressed version of a frame which can be decompressed using only the information in the I-frame itself, and without reference to other frames. They are sometimes referred to as key frames. Another type of frame is also generated, referred to herein as an inter frame, which is generated by predictive inter frame coding based on a reference frame. The reference frame can be the preceding frame, or it could be a different earlier or later frame in a sequence of frames.

A reference frame can be an inter frame itself, or can be an intra frame.

In earlier video encoding methods, a type of inter frame (known as a P frame) was generally based on a single previous frame. A different type of inter frame was based on one earlier and one later frame (such frames being referred to in the MPEG 2 standard as B-frames).

More recent video encoding standards allows the use of multiple reference frames for generating any particular inter frame. The H.264/AVC standard is one such standard. This gives a video encoder the option of choosing a particular reference frame for each macro block of a particular frame to be encoded. Generally, the optimum frame is the previous frame, but there are situations in which extra reference frames can improve compression efficiency and/or video quality. The H.264 standard allows up to 16 reference frames to co-exist. According to the H.264 standard, both the encoder and the decoder maintain a reference frame list containing short term and long term reference frames. A decoded picture buffer DPB is used to hold the reference frames at the decoder, for use by the decoder during decoding. A long term reference frame (LTR) is used to encode more than one frame, whereas a short term reference frame (STR) is generally used to encode only a single frame. However with multiple reference frames, STRs can be used as a reference by several subsequently coded frames. A particular frame could use a mix of LTRs and STRs.

While the use of multiple reference frames can improve compression efficiency and/or video quality, difficulties can arise in that the decoder can no longer assume what kind of protocol the encoder might have applied when generating an inter frame.

The reference frame list is managed by memory management control operation commands (MMCO commands) which are used by the encoder to mark frames as short term references and long term references, and to remove short term and long term frames from the reference list. Once a command has been generated at the encoder, it is transmitted with the frame that it affects over the transmission channel to the decoder. Thus the decoder can similarly access the MMCO command and assess how to decode the frame based on the previous information which was already stored at the decoder and the new information supplied by the MMCO command.

A difficulty arises in that if an MMCO command is lost during transmission, the decoder no longer has information corresponding to that which was used at the encoder for encoding the frame, and the bit stream is effectively rendered invalid due to failure of the decoder for that reason.

### SUMMARY

According to an aspect of the present invention, there is provided a method of transmitting video data comprising:
at an encoder encoding the video data as a plurality of frames, including reference frames and intermediate frames, at least some of which are encoded based on multiple reference frames;
at the encoder maintaining for each frame a current list of reference frames; and
transmitting the plurality of frames, each frame being transmitted in association with a current list of reference frames for that frame.

In this context an intermediate frame is a frame encoded (e.g. generated or predicted) from a reference frame. It is noted that a reference frame can itself be a prior generated or predicted intermediate frame. The term “reference frame” denotes a frame used to generate or predict another (intermediate) frame.

Preferably a frame number identifying each frame it transmitted with the frame so that a mapping can be maintained at a decoder between the frame number and the reference list.

Another aspect of the invention provides a method of decoding a sequence of frames representing video data, the frames including reference frames and intermediate frames each of which are encoded based on at least one reference frame, the method comprising:

receiving in association with each intermediate frame a current list of reference frames maintained for that frame at an encoder
decoding each intermediate frame with reference to the reference frames referred to in the current list for that frame.

Another aspect of the invention provides an encoder comprising: means for encoding video data as a plurality of frames, including intermediate frames, each of which is encoded based on at least one reference frame and at least some of which are encoded based on multiple reference frames; means for maintaining for each intermediate frame a current list of reference frames and means for transmitting the plurality of intermediate frames, each intermediate frame being transmitted in association with a current list of reference frames for that frame.

Another aspect of the invention provides a computer program product comprising a non-transitory computer readable medium storing thereon computer readable instructions which when executed by a processor implement the steps of encoding video data as a plurality of frames, including intermediate frames, each of which is encoded based on at least one reference frame and at least some of which are encoded based on multiple reference frames; maintaining for each intermediate frame a current list of reference frames and transmitting the plurality of intermediate frames, each intermediate frame being transmitted in association with a current list of reference frames for that frame.

Another aspect of the invention provides a decoder for decoding a sequence of frames representing video data, the frames including intermediate frames each of which are encoded based on at least one reference frame, the decoder comprising: means for receiving in association with each intermediate frame a current list of reference frames maintained for that frame as an encoder and means for decoding operable to decode the intermediate frames, wherein the means for decoding is operable to decode at least some of the intermediate frames with reference to the reference frames referred to in the current list for that intermediate frame.

For a better understanding of the present invention and to show how the same may be carried into effect reference will now be made to the following drawings.

### BRIEF DESCRIPTION OF THE DRAWINGS

FIG. 1 is schematic diagram illustrating two user terminals communicating in a communication system.

FIG. 2A is a schematic block diagram of an encoder.

FIG. 2B is a schematic block diagram of a decoder.

FIGS. 3a-3e illustrate one example case of dropped packets.

FIGS. 4a-4e illustrate another example case of dropped packets.

### DETAILED DESCRIPTION

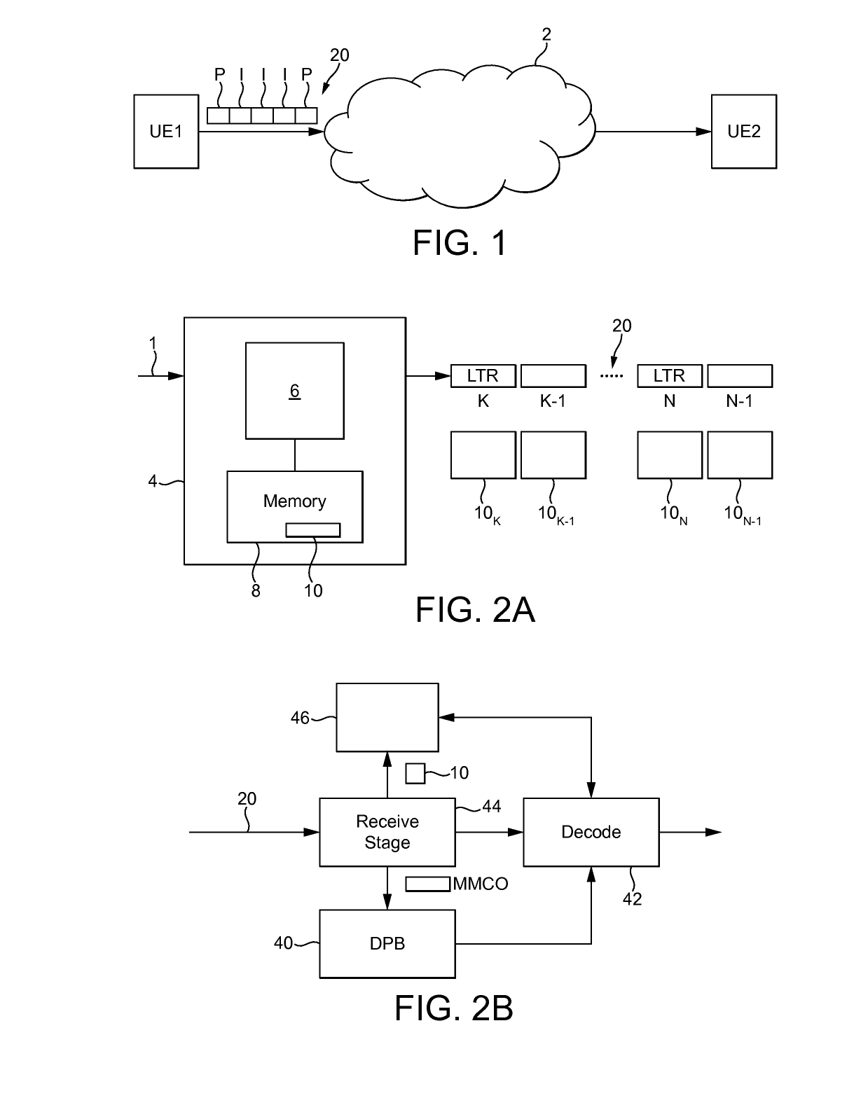

FIG. 1 illustrates in schematic form a first user terminal UE1 connected to a packet based communication system 2 such as the Internet or other packet based network. The invention is useful in the context of a VoIP-based communication system such as Skype™ where video data is transmitted in communication events which can also carry calls.

A second user terminal UE2 is also connected to the network 2. It is assumed in FIG. 1 that the user terminal UE1 is acting as a source of video data for consumption by the receiving terminal UE2. The user terminal can be in the form of any suitable device, mobile or otherwise, capable of acting as a source of video data.

In one non-restrictive embodiment, both the first and second user terminals have installed a communication client which performs the function of setting up a communication event over the network 2 and provides an encoder and decoder for encoding and decoding respectively the video stream for transmission over the network 2 in the communication event which has been established by the communication client.

The video data takes the form of a bit stream 20 comprising a series of frames which are transmitted in the form of packets. The frames include inter (P) frames and intra (I) frames. As mentioned, inter frames contain data representing the difference between the frame and one or more reference frame. Intra frames (key frames) are frames representing the difference between pixels within a frame, and as such can be decoded without reference to another frame. When encoding, frames can be marked as short term references (STRs) or long term references (LTRs), as determined by the encoder.

The decoder at the receiving terminal needs to store the STRs and LTRs for use during decoding, while ensuring that LTRs are not accidentally overwritten.

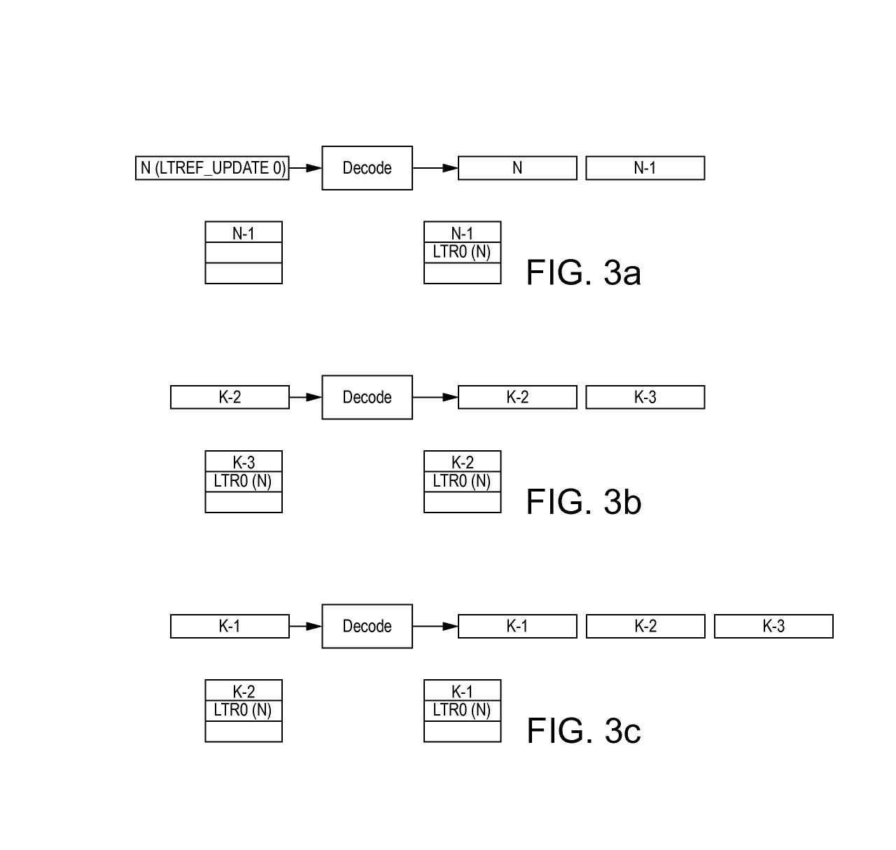

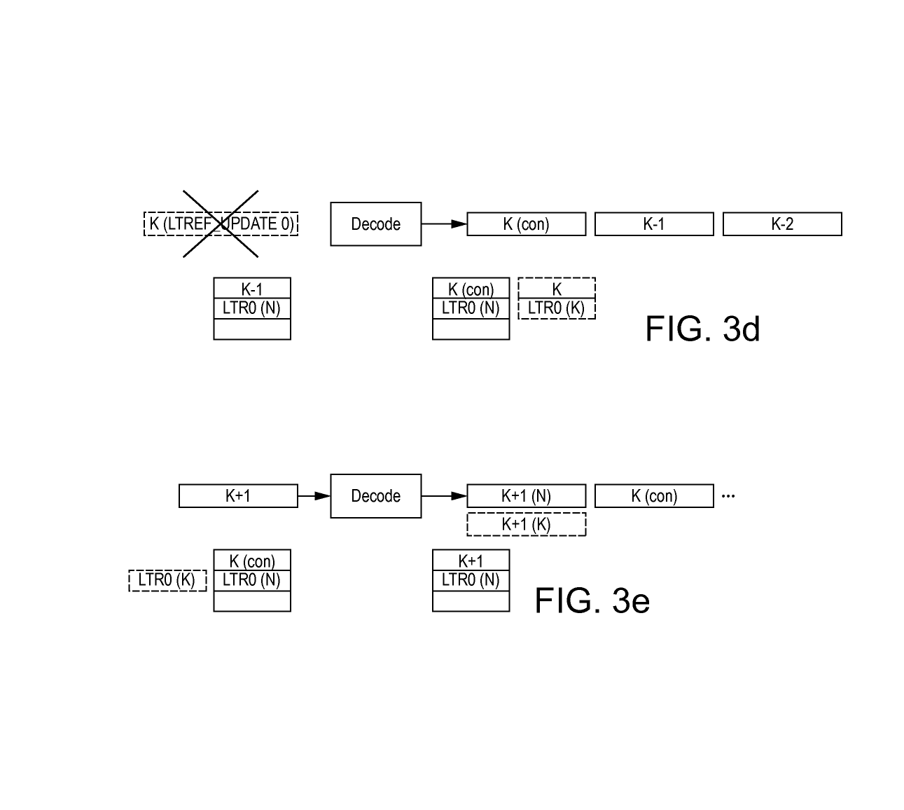

FIG. 2A is a schematic illustration of operation at an encoder for use in a user terminal of the type discussed above. The encoder 4 has a processor 6 and a memory 8. The encoder receives video data 1 (e.g. from a camera operating at the user terminal) in the form of a sequence of frames containing macro blocks which the processor encodes into frames for transmission over the network 2. The encoder operates a compression algorithm to generate a series of frames for transmission, including P frame and I frames. Each frame is associated with a frame number. The encoder maintains in the memory 8 a reference list 10. The reference frame list 10 contains short term (STR) and long term (LTR) reference frames. In the H.264 standard, a maximum of 16 is specified. The reference list at the encoder is managed using memory management control operations (MMCO) commands. Table 1 below is a list of MMCO commands, including six different MMCO commands and a stop flag. control operations (MMCO) commands. Table 1 below is a list of MMCO commands, including six different MMCO commands and a stop flag.

For each I frame, the reference list is an ordered set of reference frames used for encoding that frame.

TABLE 1

| | |
|---|---|
| 0 | Stop flag, last item in the MMCO list |
| 1 | Remove one short-term reference frame (specified as difference from |
| | current frame number) from reference list |
| 2 | Remove one LTR frame from reference list |
| 3 | Mark one short-term reference frame (specified as difference from |
| | current frame number) as LTR frame |
| 4 | Specify the maximum number of LTR frames. However, these buffers |
| | aren't yet filled. |
| 5 | Remove all reference frames |
| 6 | Mark current frame as LTR-X |

As is clear from the above Table 1, the memory management control operation commands allow short term references to be inserted (MMCO-3) and removed (MMCO-1) from the reference list. In addition, long term reference frames can be inserted (MMCO-6) and removed (MMCO-2) from the reference list. LTRs are allocated a specific location identity, e.g. LTR-0, LTR-1.

The reference list can be cleared by MMCO-5, or by the mechanism of an instantaneous decoder refresh (IDR) frame. Such a frame instantly clears the content of the reference frame list. A flag (Long_Term_Reference_Flag) specifies if the IDR frame should be marked as a long term reference frame. An LTR is distinct from an STR frame because an STR frame can be overwritten in a buffer by a sliding window process (described later), whereas an LTR frame stays until it is explicitly removed.

FIG. 2A illustrates an output of the encoder in the form of a series of packets, each packet representing a frame. It is assumed for the sake of the following discussions that an N series of frames was first encoded (of which N−1 and N are shown in FIG. 2A), followed by a K series of frames (of which K−1 and K are shown). Frame N was marked as a long term reference for use by the N series and subsequently frame K was marked as a long term reference. Frames generated by the encoder and not marked “unused for reference” are assumed to act as short term reference frames. The frames are transmitted to a decoder which include a decode picture buffer DPB. A long term reference frame can be placed in a first buffer location LTR-0 or a second buffer location LTR-1 based on its location identity. One frame cannot exist in both buffers at the same time.

In existing systems, MMCO commands are sent with their associated P frames, such that if a P frame is lost, the associated MMCO command is also lost. Whereas the frame itself can be recovered by, for example, concealment techniques which fall outside the scope of the present application but which are known in the art, the loss of MMCO commands can cause undefined situations to exist for the decoder and as a consequence, a failure of the decoder.

According to embodiments of the present invention, the video stream 20 includes reference lists. Each intermediate frame (I-frame) is sent with a frame number and a current list 10 of reference frames used to encode it. The list 10 carries the prefix N,K etc. associated with each frame.

The encoder generates a list of reference frames used by the current frame. In addition, it also reports the frame number of current frame. This enables the frame number and reference list to use same frame indexing. Both the frame number and reference list are transferred to the decoder, as side information, for each frame. The decoder receives the frame number for each frame, and can therefore create a mapping between the frame number and the internal frame indexing.

It is noted in this respect that the H264 Standard provides a parameter frame_num which is the internal frame indexing in the bitstream. However, existing encoders can decide to assign only a small number of bits to it, such that it will loop around very quickly, e.g., to 16. Since long term reference frames can stay in the DPB much longer, this index number is not enough for the purpose of mapping reference frames in the buffer.

Further, frame_num is reset on a key frame, so using frame_num in feedback information from a receiver may be ambiguous, especially if feedback delay is long and jittery.

It is important that the indexing used for frame number and the reference list must be the same, so since the encoder generates the reference list, it should also generate the fame numbers to identify frames such that synchronization can be maintained between the reference list and the contents of the buffer.

FIG. 2B is a schematic block diagram illustrating functions at a decoder. The decoder can be located for example at the second user terminal UE2 and arranged to receive the transmitted video stream 20 from the user terminal UE1. It will readily be appreciated that both user terminals can have encoders and decoders.

The decoder comprises a decode picture buffer DPB40 and a decode function 42 which operates to decode frames received in the video stream 20 based on the contents of the decode picture buffer 40 as described in more detail in the following. A receive stage 44 of the decoder controls the contents of the video stream to supply frames for decoding to the decode stage 42, and MMCO commands for keeping the decode picture buffer up to date, again as described in more detail in the following. In addition, in accordance with embodiments of the invention, the receive stage 44 holds a current list 10 for the currently received frame in a memory 46.

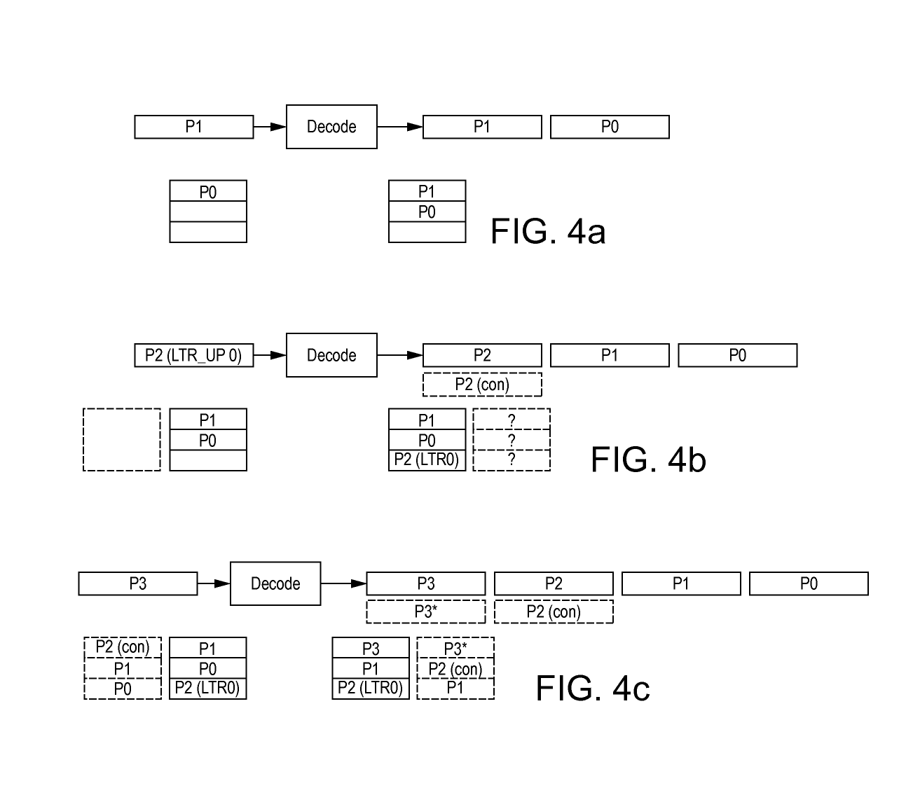

FIGS. 3a to 3e illustrate a typical scenario on the decode side, where the decoder is receiving the sequence of frames emitted by the encoder of FIG. 2A. At each stage of the decoding process, the left hand side shows the incoming packet and the state of the decode buffer DPB prior to decode. On the right hand side is shown the decoded packet stream, with the state of the decode buffer DPB after the decode stage. The decode buffer operates according to a sliding window process, that is, on a first-in-first-out basis. Frames marked as long term references however are not subject to the sliding window process and are retained in the buffer.

According to FIG. 3a, a packet N arrives, attached to an LT REF_UPDATE 0 command. This frame is placed in the buffer, and as there is a slot free, the frame N−1 is retained and the long term reference frame N is placed in the buffer as well, at location LTR0.

FIG. 3b shows arrival of the packet K−2 which is not attached to an MMCO command. Prior to receipt, the buffer includes the previous frame K−3 and the long term reference frame N. The incoming frame K−2 pushes out the frame K−3, but the long term reference frame N is retained. The maximum number of “vacant slots”, i.e. the size of the buffer, is determined by a parameter (e.g. maximum_ref_frames in the H264 Standard). In the preceding example, the buffer size is set at 2.

In FIG. 3c, a similar process is applied to the subsequent frame K−1. In FIG. 3d, the next frame which was transmitted by the encoder is frame K, but FIG. 3d illustrates the situation where this frame has been dropped during transmission. In this case, frame K had an LT REF_UPDATE 0 command attached, which was intended to have frame K replace frame N as the next long term reference at LTR0. The decoder recognizes that frame K has been dropped and attempts to regenerate it using a concealment process, to provide the frame marked K (Con). However, it did not know about the loss of the MMCO command and thus does not replace the long term reference frame N. The dotted version illustrates what the decode buffer should now hold, whereas the full line version illustrates what it actually holds.

On receipt of the next frame K+1, this frame is expecting according to the frame reference list established at the encoder to use as its reference frame, frame K which it expects to now be held at LTR0. In fact, the frame held at that reference is N and so the decoder will be undefined and fail or incorrectly decode frame K+1. Moreover, as there is nothing to hold concealed frame K in the decode buffer, the incoming frame K+1 displaces it completely at the end of decode stage shown in FIG. 3e.

In embodiments of the present invention, this problem is overcome by transmitting with each frame the current reference frame list 10 established at the encoder. In the case therefore of a missing frame (K in FIG. 3d), the decoder can recognize that the frame is missing and generate a concealed version in a known fashion. More importantly, the encoder should make sure not to refer to this frame when it has been pushed out of the buffer.

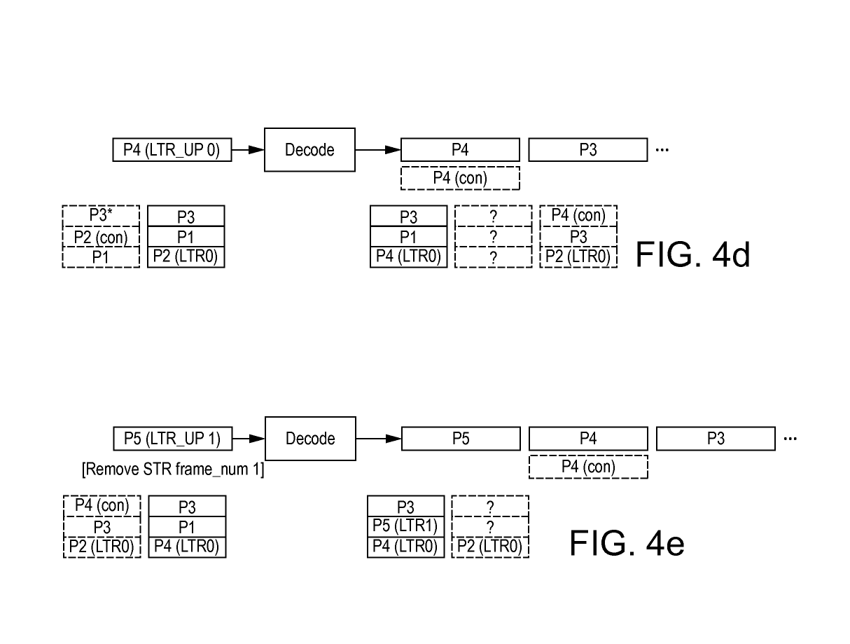

FIGS. 4a to 4e illustrate another exemplary scenario of the effect of lost packets. In this case, the packet frame sequence produced by the encoder is P0, P1, P2, etc. where each packet represents a frame of the corresponding number. In the decode stage represented in FIG. 4a, the incoming frame P1 is moved into the decode picture buffer and the preceding frame is pushed down one in the buffer.

The next frame P2, has an MMCO command LT REF_UPDATE 0 which would, if received, cause the frame to be stored in the last remaining empty location of the buffer as shown on the right hand side of FIG. 4b. That is, according to H264 Standard, LTRs are stored at the end of the reference list, but other implementations are possible. If the packet however is not received, the decode stage after decoding is undefined, until it becomes resolved.

In one implementation of the encoder, the effect of the decode process is as shown in dotted lines on the left hand side of FIG. 4c. That is, a concealed version of frame P2 is generated by the decoder which is placed at the top of the buffer on a sliding window basis. When the next frame P3 is received, the frame which is labeled P3* is generated which would use the concealed version of frame 2 as a short term reference and would not be aware that the frame P2 should be a long term reference.

This is a reason why it is advantageous that the transmitted out of band reference list is ordered. In the coded macroblocks themselves, reference frames are identified only by their position in the list, not explicitly whether their reference is STR or LTR. In this example, reference frames P2 and P1 have switched position due to the loss and reference indices will point to the wrong frame.

Moreover, when the next frame P4 is received (which in this case happens to include an update reference command), the buffer is now full because there is no allocated long term position LT0 in the buffer, and thus (in the H264 Standard) the decoding process is undefined and fails at that point. This is illustrated by the question marks in the dotted version of the buffer on the right hand side of FIG. 4d.

This problem can be solved in embodiments of the invention by transmitting with each frame the current frame reference list as generated at the encoder. This would then allow the subsequent frame P4 with the update reference command to operate properly to replace the existing LTR slot from P2 to P4. In this case, it would be clear where the missing frame was intended to be by virtue of the position it occupies in the reference list. This position is given by the transmitted reference list. However, If there is no free frame slot in the buffer then the decoder removes the oldest STR from the buffer. If there is no STR, then it removes the oldest LTR.

In the event that the frame P2 with the MMCO update command is received, but the frame P4 with the MMCO update command is not, a different problem arises. In this case, the buffer has the appearance in full lines on the left hand side of FIG. 4d when the frame P4 fails to materialize. In that case, a concealed version of P4 is generated P4 (Con) and placed in the buffer replacing P3 which replaces P1 on a sliding window basis.

When subsequent frame P5 is received, the picture buffer is full and there is no allocated long term position LTR1. To create this, the MMCO attached to frame P5 has a command to remove short term frame_num 1 (P1). This frame does not exist due to the sliding window recovery applied for lost frame 4, and so the decoder fails.

This problem can be solved in embodiments of the invention by transmitting with each frame the current frame reference list as generated at the encoder. In this case, therefore, it would be clear that missing frame P4 was intended P1, by virtue of its position in the transmitted reference list. Thus the same P5 could be decoded based on the concealed version of P4, and would then correctly be in the buffer at LTR1 for later decoding.

Thus, the transmitted reference list can be accessed by the decode function 42 in the case where there is a loss of frames in the video stream. Frame loss can be detected without using the reference list, for example, in the H264 Standard a frame_num_syntax element is transmitted in the H264 bitstream and thus can be detected by a gap in the sequence of frame_num's.

When loss is detected, the reference list is used by the decoder to resolve undefined decoder situations occurring due to the loss (for example as described in the foregoing), to improve the behavior of the decoder during a loss situation. For example, in FIG. 4C, the order of the list of frames in the DPB could be ambiguous due to loss, but the externally transmitted reference map which can be accessed from the memory 46 in that case will mitigate this.

The reference list 10 can be generated at the encoder during the encoding process as discussed above. Alternatively, it can be generated by a separate module outside of the encoder that passes the encoded bit stream.

The described embodiments of the invention provide an improved robustness when compared to earlier systems. The communication of a list of reference frames from the encoder to the decoder enables flexible reference frame management and long term recovery logic on lossy channels. It is particularly useful in the context when the underlying codec is not ideally designed for lossy channels in any event.

It should be understood that the block and flow diagrams may include more or fewer elements, be arranged differently, or be represented differently. It should be understood that implementation may dictate the block and flow diagrams and the number of block and flow diagrams illustrating the execution of embodiments of the invention. It should be understood that elements of the block and flow diagrams described above may be implemented in software, hardware, or firmware. In addition, the elements of the block and flow diagrams described above may be combined or divided in any manner in software, hardware, or firmware. If implemented in software, the software may be written in any language that can support the embodiments disclosed herein. The software may be stored on any form of non-transitory computer readable medium, such as random access memory (RAM), read only memory (ROM), compact disk read only memory (CD-ROM), flash memory, hard drive, and so forth. In operation, a general purpose or application specific processor loads and executes the software in a manner well understood in the art.

While this invention has been particularly shown and described with references to example embodiments thereof, it will be understood by those skilled in the art that various changes in form and details may be made therein without departing from the scope of the invention encompassed by the appended claims.

What is claimed is:

1. A method of transmitting video data comprising:
at an encoder encoding the video data as a plurality of frames, including intermediate frames, each of which is encoded based on at least one reference frame and at least some of which are encoded based on multiple reference frames;
at the encoder maintaining for each intermediate frame a current list of reference frames; and
transmitting the plurality of intermediate frames, each intermediate frame being transmitted in association with a current list of reference frames for that frame.

2. A method according to claim 1, comprising the step of generating and transmitting at least one key frame as a compressed version of a source video frame, said key frame constituting a reference frame.

3. A method according to claim 1, wherein the current intermediate frame is encoded based on a preceding reference frame in a sequence of frames.

4. A method according to claim 1, wherein the current intermediate frame is encoded based on a subsequent reference frame in a sequence of frames.

5. A method according to claim 1, wherein each intermediate frame is generated using predictive inter frame coding based on said at least one reference frame.

6. A method according to claim 1 comprising, at the encoder, marking at least one of said reference frames in the list as a long term reference frame, thereby indicating that the reference frame is to be stored until subject to an update command.

7. A method according to claim 1, including, at the encoder, marking at least one of said reference frames in the list as a short term reference frame, thereby indicating that the reference frame can be overwritten without being subject to an update command.

8. A method according to claim 5, wherein the step of marking includes appending to the marked frame a memory management command indicating the status of the frame, said command being transmitted with the frame.

9. A method according to claim 5, wherein the step of marking a frame as a long term reference frame includes identifying a buffer location for the long term reference frame.

10. A method according to claim 1 wherein the step of encoding comprises receiving a frame of a moving image, the frame comprising multiple macro blocks;
wherein each macro block is encoded using a respective reference frame.

11. A method according to claim 1 wherein the list of reference frames identifies at least one intermediate frame.

12. A method according to claim 1 wherein the list of reference frames identifies at least one key frame.

13. A method according to claim 1 wherein the list comprises an ordered set of reference frames, each reference frame having a position in the ordered set.

14. An encoder comprising:
means for encoding video data as a plurality of frames, including intermediate frames, each of which is encoded based on at least one reference frame and at least some of which are encoded based on multiple reference frames;
means for maintaining for each intermediate frame a current list of reference frames; and
means for transmitting the plurality of intermediate frames, each intermediate frame being transmitted in association with a current list of reference frames for that frame.

15. An encoder according to claim 14 comprising means for generating at least one key frame as a compressed version of a source frame, said key frame constituting a reference frame.

16. An encoder according to claim 14 comprising means for marking at least one of said reference frames in the list as a long term reference frame.

17. An encoder according to claim 14 comprising means for marking at least one of said reference frames in the list as a short term reference frame.

18. A computer program product comprising a non-transitory computer readable medium storing thereon computer readable instructions which when executed by a processor implement the steps of:
encoding video data as a plurality of frames, including intermediate frames, each of which is encoded based on at least one reference frame and at least some of which are encoded based on multiple reference frames;
maintaining for each intermediate frame a current list of reference frames; and
transmitting the plurality of intermediate frames, each intermediate frame being transmitted in association with a current list of reference frames for that frame.

19. A method of decoding a sequence of frames representing video data, the frames including intermediate frames each of which are encoded based on at least one reference frame, the method comprising:
receiving in association with each intermediate frame a current list of reference frames maintained for that frame at an encoder,
decoding at least some of the intermediate frames with reference to the reference frames referred to in the current list for that frame.

20. A method according to claim 19 comprising maintaining a decode buffer based on commands received with the video data, wherein the decode buffer identifies reference frames for decoding intermediate frames.

21. A method according to claim 20, further comprising the step of detecting that a frame has not been received; and
using the current list for the last received frame to identify reference frames for decoding at least one subsequent intermediate frame.

22. A decoder for decoding a sequence of frames representing video data, the frames including intermediate frames each of which are encoded based on at least one reference frame, the decoder comprising:
means for receiving in association with each intermediate frame a current list of reference frames maintained for that frame at an encoder; and
means for decoding operable to decode the intermediate frames, wherein the means for decoding is operable to decode at least some of the intermediate frames with reference to the reference frames referred to in the current list for that intermediate frame.

23. A decoder according to claim 22 comprising a store for holding a current list of reference frames for each intermediate frame.

24. A decoder according to claim 22 comprising a decode picture buffer identifying reference frames for decoding intermediate frames, wherein the decoding means is operable in the event of loss of a received frame to use the current list for the last received frame to identify reference frames for decoding at least one subsequent intermediate frame.

25. A method according to claim 1 comprising transmitting with each intermediate frame a frame number identifying that frame.

26. An encoder according to claim 14 comprising means for identifying each frame with a frame number, said frame number transmitted with each frame.

27. A computer program product according to claim 18 which is arranged when executed to transmit with each intermediate frame a frame number identifying that frame.

28. A method according to claim 19 comprising receiving with each intermediate frame a frame number identifying that frame and maintaining a mapping between the frame number and the reference list.

29. A decoder according to claim 22 comprising means for maintaining a mapping between a frame number received with each frame and an internal index number reviewed in the video data.
